(19) United States
(12) Patent Application Publication
(10) Pub. No.: US 2005/0033654 A1
(43) Pub. Date: Feb. 10, 2005

(54) Online shopping method and system

(76) Inventors: Kenjiro Takagi, Kawasaki (JP); Nobuya Okayama, Kawasaki (JP); Shigeru Iida, Tokyo (JP); Hiroko Nakagawa, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/680,225

(22) Filed: Oct. 8, 2003

(30) Foreign Application Priority Data
Aug. 8, 2003 (JP) 2003-206639

(51) Int. Cl. G06F 17/60

(52) U.S. Cl. 705/26

(57) ABSTRACT

If a commodity desired to purchase is selected in a purchaser terminal, a list of users (information providers) having a purchase history of the commodity at a shopping site is displayed. The purchaser terminal exchanges messages in real time with an information terminal of an information provider selected from the list, and obtains information concerning the commodity (information provision). In the case where the purchaser purchases the commodity, its commodity ID and a user ID of the information provider are associated with each other and stored in a shopping site operation apparatus. After the purchase of the commodity, a comment and/or evaluation concerning the information provision are input. On the basis of the comment and/or evaluation, privilege is granted to the information provider. The comment and/or evaluation are reflected in information of the information providers.

### BACKGROUND OF THE INVENTION

The present invention relates to an online shopping method, and system, in a shopping site. In particular, the present invention relates to an online shopping method, and system, in which information of commodities can be obtained by information exchange between individuals.

Online shopping is activated by development of communication such as Internet and potable telephones. As a conventional method for informing purchasers of detailed information concerning commodities, a technique for a seller to open images, functions, specification information of commodities to the public and present comments is disclosed in JP-A-05-165856. In the case of music contents, audition for a fixed time is possible in some cases. In the case of book contents, the stand-up reading function, which allows content summarizing and reading for a fixed time, is provided in some cases. In some cases, purchasers evaluate commodities, open the results of the evaluation to a shopping site, and thereby provide other purchasers with detailed information after use, such as feeling of use and evaluation of contents.

In a messenger program, information, such as a name, a nickname, hobbies and sports, is previously registered for each individual. When retrieving a member with desire to exchange information, therefore, conditional retrieval of other members can be performed. By specifying an individual, information can be exchanged with a person having a similar hobby and a person having the same interest.

### SUMMARY OF THE INVENTION

In the above-described conventional technique, the seller's subjective element is involved. For example, in the case where commodities are like in specifications and there is a difference in price, the seller tends to recommend a commodity that contributes more largely to the amount sold. Thus there is a problem that information cannot be said to be necessarily accurate. As another problem, it can be mentioned that persons who volunteer to provide information are limited because information providers cannot get merits and information that purchasers desire to know is not always written on a message board. As for a problem in the messenger, a plurality of messenger accounts can be registered and false information can also be registered, and consequently it can be considered that reliability is low in the case where there is only online communication between the purchaser and the other party. In addition, in the conditional retrieval in the messenger, retrieval cannot be conducted to determine which commodities were used by members.

An object of the present invention is to provide an online shopping system in which a purchaser can obtain information the purchaser wants to know about a commodity, from an information provider in real time.

In order to achieve the object, according to the present invention, information providers included in information providers concerning a commodity that a purchaser is about to purchase and currently logged on to a shopping site are displayed. Messages that are exchanged between an information provider selected from among the displayed information providers and the purchaser are stored. A privilege is granted to the information provider according to evaluation of information provided from the information provider.

Other objects, features and advantages of the invention will become apparent from the following description of the embodiments of the invention taken in conjunction with the accompanying drawings.

### BRIEF DESCRIPTION OF THE DRAWINGS

FIG. 1 is a configuration diagram of an information exchange system in online shopping that is an embodiment of the present invention;

FIG. 2 is a flowchart showing a processing procedure used at the time of commodity purchase in an embodiment of the present invention;

FIG. 3 is a flowchart showing a processing procedure used after commodity purchase in an embodiment of the present invention;

FIG. 4 is a diagram showing an example of information provider data held by a user information management unit 123;

FIG. 5 is a diagram showing an example of commodity information data held by a commodity information management unit 122;

FIG. 6 is a diagram showing an example of data transmitted from a purchaser terminal 100 to a shopping site operation apparatus 120 at step 214 shown in FIG. 2;

FIG. 7 is a diagram showing an example of data transmitted from a purchaser terminal 100 to a shopping site operation apparatus 120 at step 301 shown in FIG. 3;

FIG. 8 is a diagram showing an example of data indicating information providers with whom a certain user has exchanged information, in an embodiment of the present invention;

FIG. 9 shows a view example of a shopping site displayed on a purchaser terminal in an embodiment of the present invention;

FIG. 10 shows a view example of a messenger program executed by a dedicated messenger processing unit in an embodiment of the present invention;

FIG. 11 shows an example of an evaluation result input view displayed at step 301 shown in FIG. 3; and

FIG. 12 shows an example of a confirmation view of user information displayed at steps 305 and 306 shown in FIG. 3.

### DETAILED DESCRIPTION OF THE EMBODIMENT

Hereafter, a preferred embodiment of the present invention will be described in detail with reference to the drawings. By the way, the present invention is not restricted thereby.

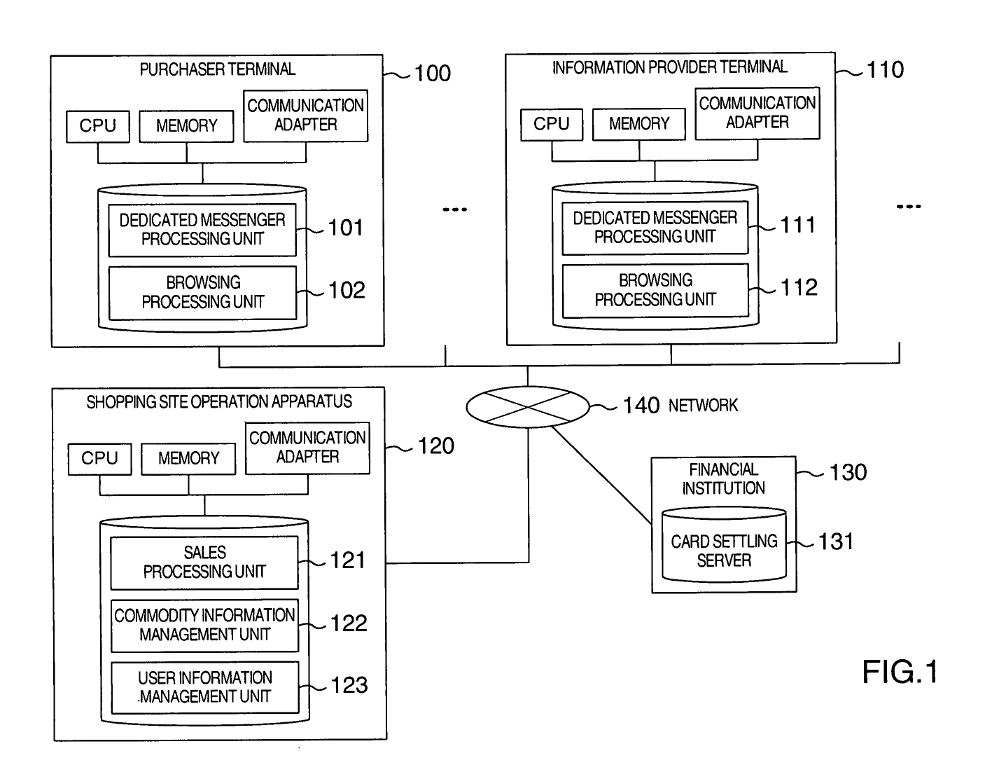

FIG. 1 is a general configuration diagram of an online shopping system that is an embodiment of the present invention. The present system includes a purchaser terminal 100 to be used by a purchaser, an information provider terminal 110 to be used by an information provider, an online shopping site operation apparatus 120 owned by an online shopping site operation corporation, and a financial institution server 130. They are connected to each other via a network 140. The purchaser is a user who is about to purchase a commodity in a shopping site. The information provider is a user who has a purchase history of a commodity in the shopping site and provides information concerning the commodity.

The purchaser terminal 100 includes a dedicated messenger processing unit 101 for transmitting and receiving a message, and a browsing processing unit 102, which makes possible to peruse Internet home page. In the same way, the information provider terminal 110 also includes a dedicated messenger processing unit 111 and a browsing processing unit 112.

A basic performance of the dedicated messenger processing unit 101 and the dedicated messenger processing unit 111 is to be able to exchange a message with a specific user online in real time. Upon being started, the dedicated messenger processing unit 101 and the dedicated messenger processing unit 111 are in a state in which a message can also be transmitted and received. In addition to the basic performance, the dedicated messenger processing unit 101 and the dedicated messenger processing unit 111 respond to a choice of a commodity at the shopping site by displaying information providers who have a purchase history of the commodity and are now in the online state.

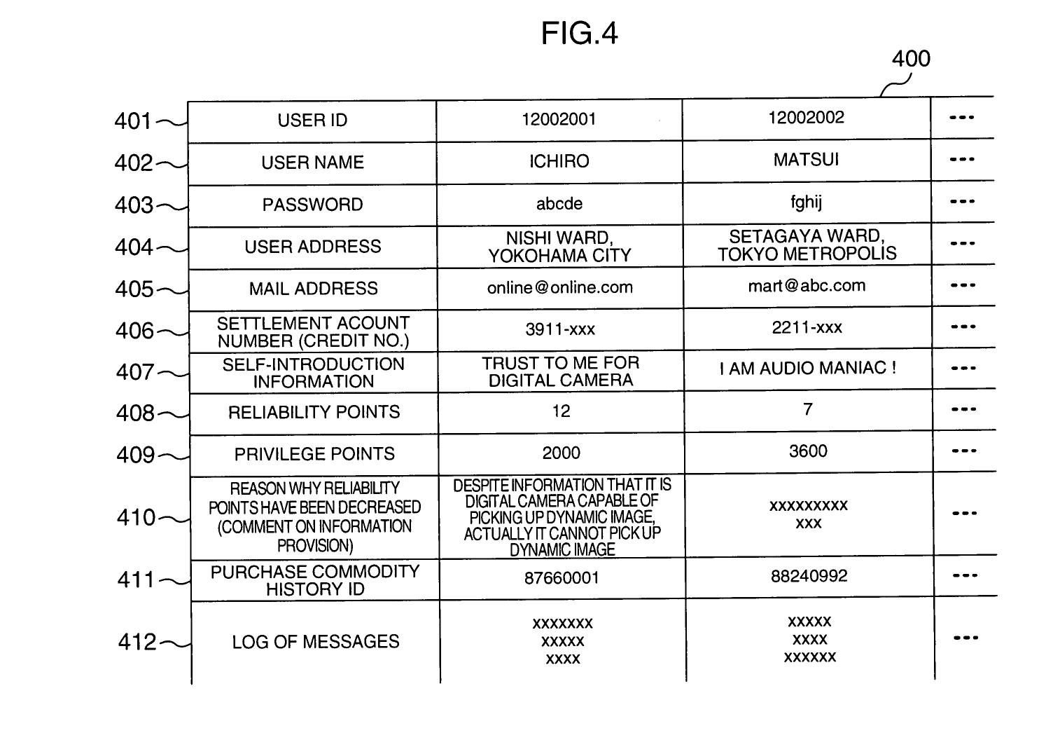

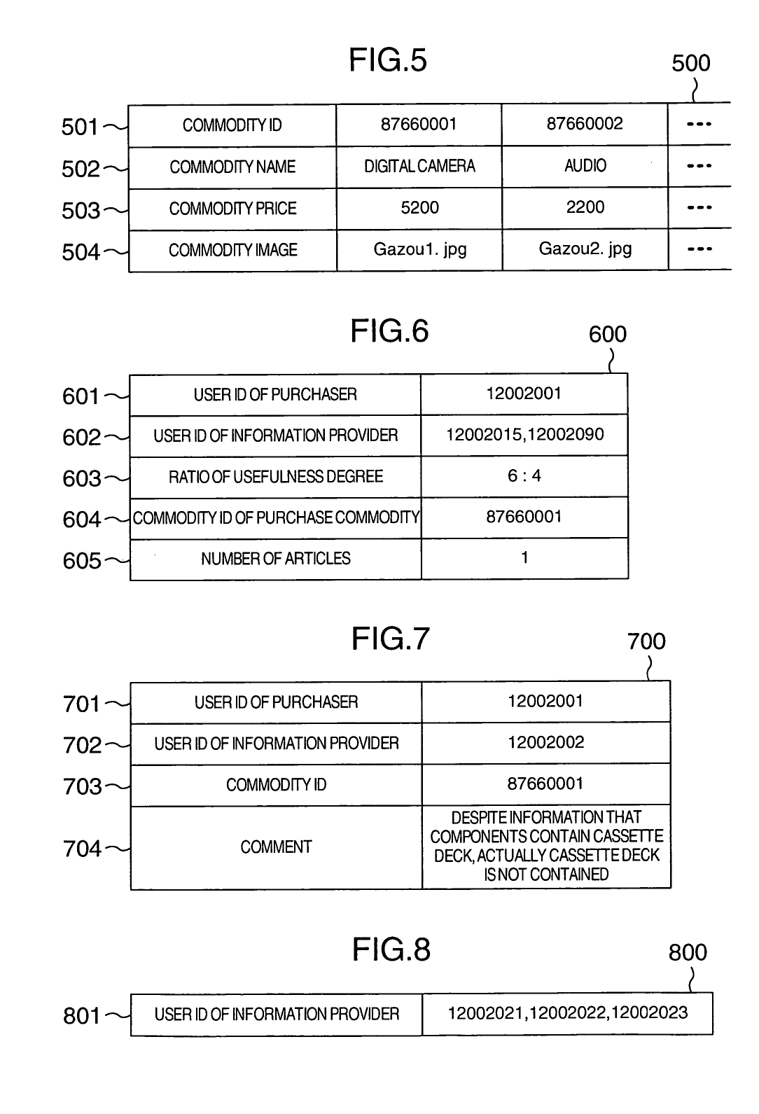

The online shopping site operation apparatus 120 installed in the online shopping site operation corporation includes a sales processing unit 121 for conducting sales processing of a commodity in the online shopping, a commodity information management unit 122 for managing information of commodities to be sold as a commodity data table 500 shown in FIG. 5, and a user information management unit 123 for managing information concerning users who used the online shopping as a user data table 400 shown in FIG. 4. Details of the user data table 400 shown in FIG. 4 and the commodity data table 500 shown in FIG. 5 will be described later.

In the case where the purchaser and the information provider exchange information by using the dedicated messenger, processing of temporarily storing a transmitted message in the user information management unit 123 as a log via the network 140 and transmitting the message to its destination is executed.

As shown in FIG. 1, each of the purchaser terminal 100, the information provider terminal 110 and the shopping site operation apparatus 120 includes a CPU serving as a processing unit, a memory serving as a storage device, and a communication adapter for conducting transmission and reception of information with an external device. In addition, each of the purchaser terminal 100, the information provider terminal 110 and the shopping site operation apparatus 120 includes a storage (not illustrated), such as a hard disk device, for storing information to be transmitted and received information.

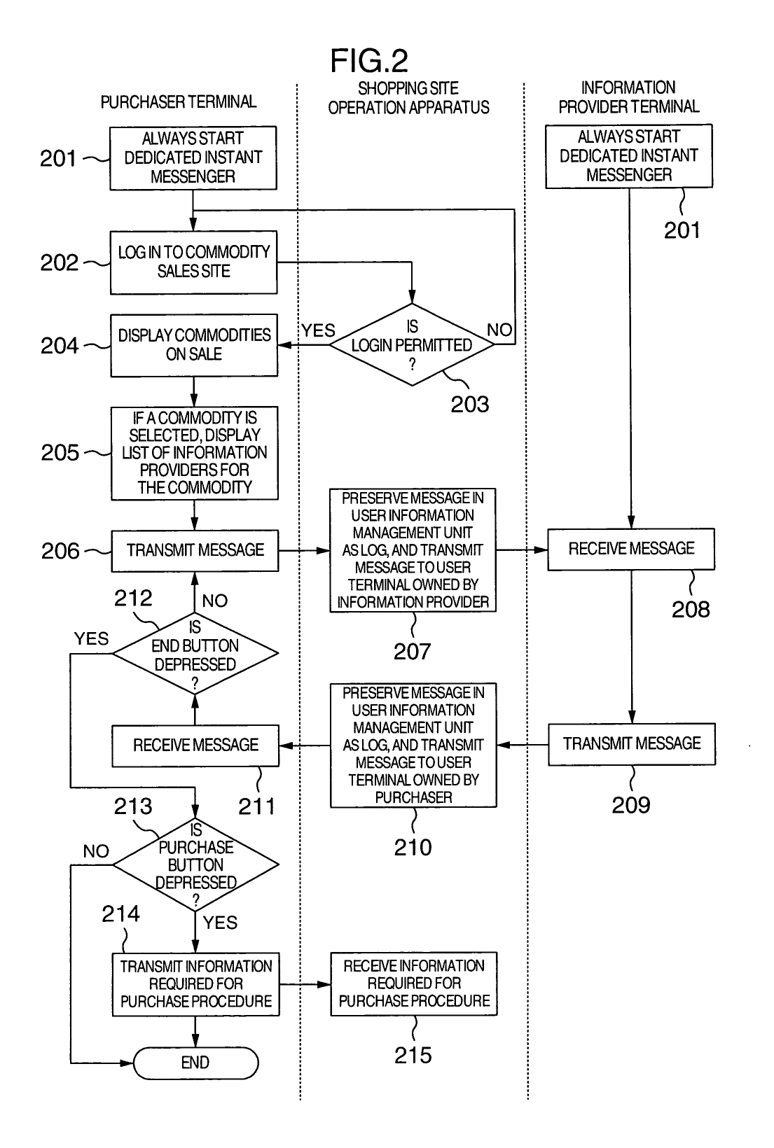

FIG. 2 is a flowchart showing a processing procedure used among the purchaser terminal 100, the information provider terminal 110 and the shopping site operation apparatus 120 at the time of commodity purchase in the present embodiment.

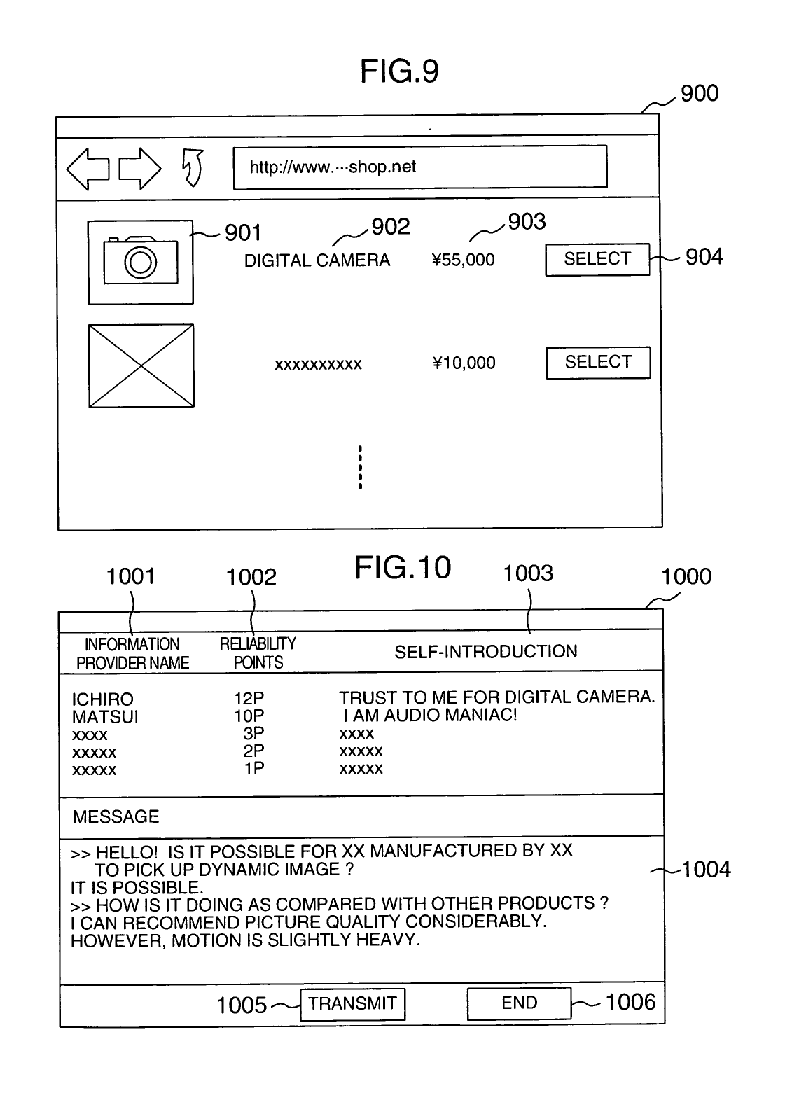

In both the purchaser terminal 100 and the information provider terminal 110, the dedicated messenger processing unit 101 and the dedicated messenger processing unit 111 start a messenger program and cause the online state (step 201). Subsequently, the purchaser terminal 100 accesses the online shopping site, inputs an ID and a password of the user, and conducts login (step 202). If the login is not permitted (No at step 203), then the purchaser terminal 100 returns to the step 202 and re-inputting is requested. If the login is permitted (Yes at step 203), then the browsing processing unit 102 displays information concerning commodities on sale on the browser (step 204). The commodity information displayed at this time is the commodity data table 500 shown in FIG. 5 and described later. Its display view is a shopping site view 900 shown in FIG. 9 and described later.

If a certain commodity is selected from among commodities displayed at the step 204, a commodity ID of that commodity is transmitted to the shopping site operation apparatus 120 via the network 140. The shopping site operation apparatus 120 retrieves and extracts information providers who are information providers having a purchase history of the commodity and who are in the online state (currently logged on to the shopping site), from the user data table 400 stored in the user information management unit 123, and transmits the information providers to the purchaser terminal 100. The purchaser terminal 100 displays a list of the transmitted information providers (step 205).

In the case where the purchaser terminal 100 sends a message selected from among the information providers displayed at the step 205, the dedicated messenger processing unit 101 accepts the message input by the purchaser, and transmits the input message to the shopping site operation apparatus 120 (step 206). The message is transmitted from the communication adapter to the shopping site operation apparatus 120 via the network. The shopping site operation apparatus 120 preserves a log of the received message in the user information management unit 123. In addition, the shopping site operation apparatus 120 transmits the received message to an information provider terminal 110 of an information provider that is the destination of the message via the network 140 (step 207).

The information provider terminal 110 receives the message (step 208). In the information provider terminal 110 that has received the message, the browsing processing unit 112 displays the message. In the case where the information provider provides information in response to the displayed message, the dedicated messenger processing unit 111 in the information provider terminal 110 accepts a return message, and transmits the return message input by the information provider (step 209). The shopping site operation apparatus preserves a log of the received message in the user information management unit 123, and transmits the message to the purchaser terminal 100 of the transmission destination (step 210). The purchaser terminal 100 receives the message (step 211). In the purchaser terminal 100, the steps 206-212 are repeated until an end order is given. In other words, message transmission and reception are conducted between the purchaser terminal 100 and the information provider terminal 110 until the end order is given. In other words, message exchange may be conducted between the purchaser terminal 100 and the same information provider terminal a plurality of times, or message exchange may be conducted between the purchaser terminal 100 and a plurality of information provider terminals.

If information to the effect that the user of the purchaser terminal 100 has decided to purchase a certain commodity is input to the purchaser terminal 100 as a result of information provision in transmission and reception of the message, for example, if a “purchase button” is depressed in a view on the purchaser terminal 100 (Yes at step 213), then the browsing processing unit 102 accepts inputting of the user ID of the user and the commodity ID of the commodity desired to purchase, which are information required for a purchase procedure, and transmits the input information to the shopping site operation apparatus 120 (step 214). If the shopping site operation apparatus 120 has received the information required for the purchase procedure, then the sales processing unit 121 conducts sales processing according to the received information. If information to the effect that the user has decided to purchase is not input to the purchaser terminal 100 (No at the step 213), then the user peruses other commodities or terminates the shopping. By the way, details of the information required for the purchase procedure input at the step 214 will be described later with reference to FIG. 6.

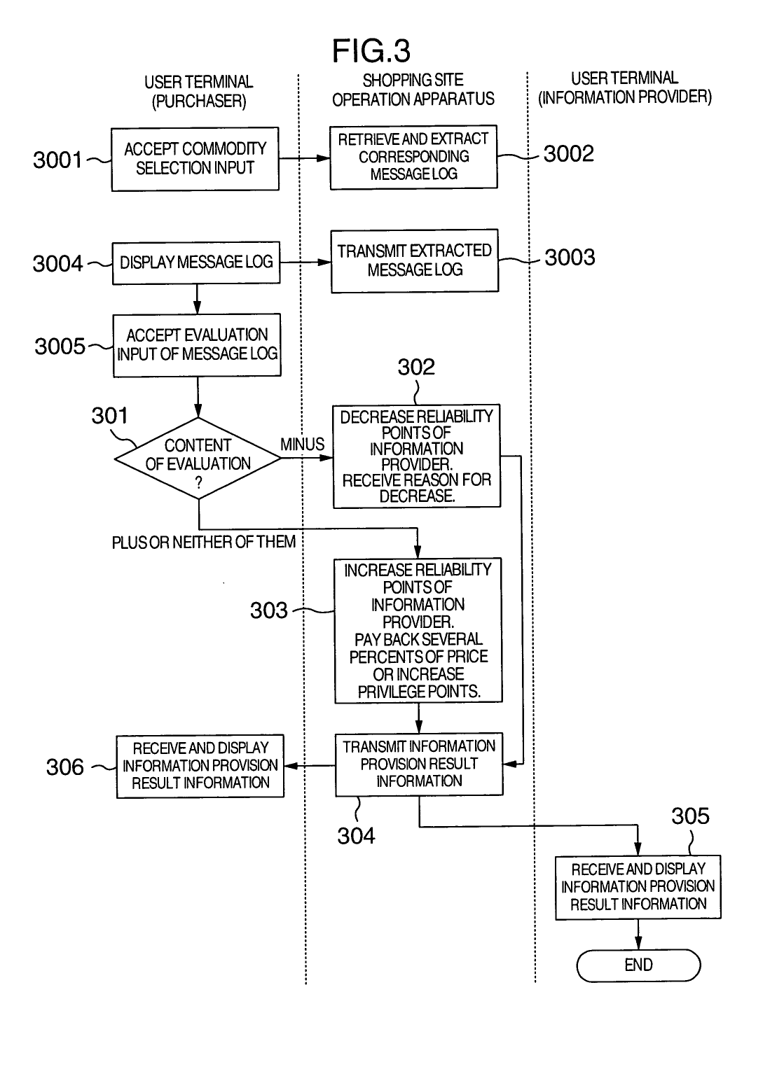

FIG. 3 is a flowchart showing a processing procedure used among the purchaser terminal 100, the information provider terminal 110 and the shopping site operation apparatus 120, as regards evaluation of provision of the information and privilege granting concerning the commodity, after the commodity purchase in the present embodiment. An example in which the processing procedure shown in FIG. 3 is applied several days after the commodity desired by the purchaser has come to hand of the purchaser in the present embodiment will now be described.

First, the purchaser terminal 100 logs in to the shopping site, and accepts the purchaser's selection of a commodity for which the purchaser desires to input a comment and evaluation, from a list of commodities purchased by the purchaser (step 3001). The purchaser terminal 100 transmits a commodity ID of the selected commodity and a user ID of the purchaser who has logged in, to the shopping site operation apparatus 120. On the basis of the received commodity ID and user ID, the shopping site operation apparatus 120 retrieves and extracts contents of information provision concerning the commodity (a message log 412 shown in FIG. 4) from the user information management unit 123 (step 3002). Subsequently, the shopping site operation apparatus 120 transmits the extracted message log to the purchaser terminal 100 (step 3003). At this time, the shopping site operation apparatus 120 may also transmit information (such as a commodity name, model No. and purchase date) relating to the commodity ID together with the message log.

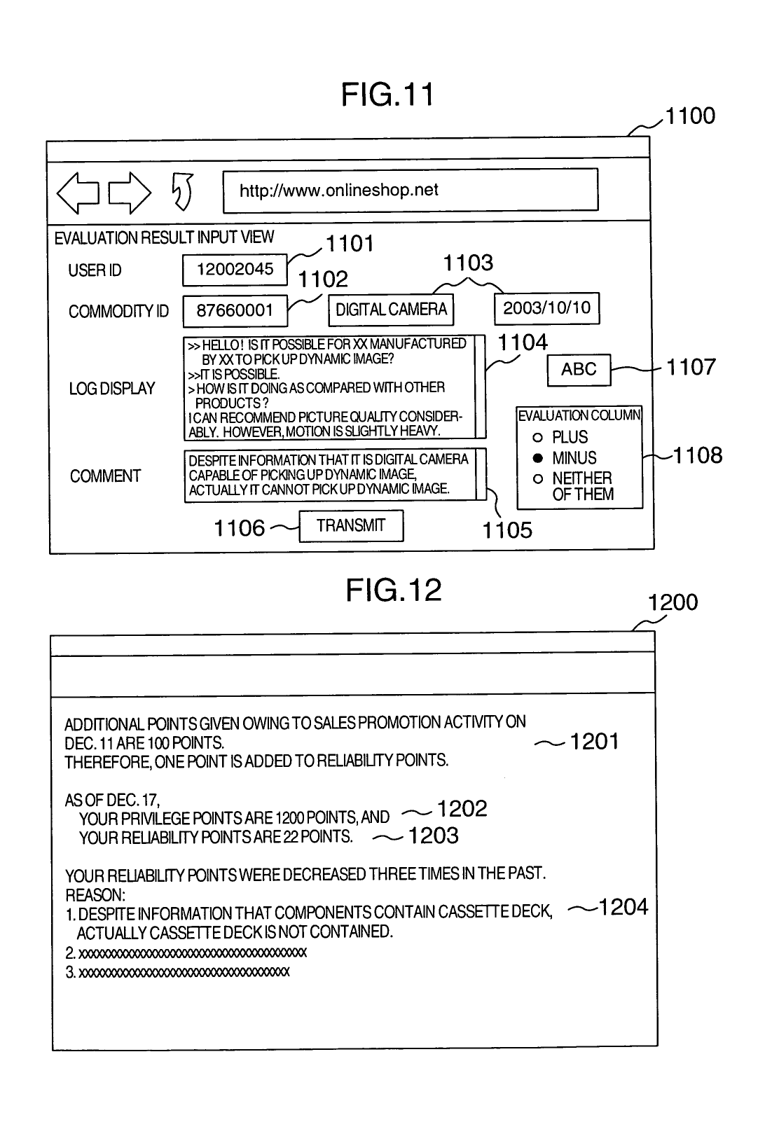

The purchase terminal 100 displays the received message log (step 3004). An example of a view displayed at this time is shown in FIG. 11. Subsequently, inputting of information that indicates evaluation of the contents of information provision (the message received at the steps 209 to 211 shown in FIG. 2) concerning the commodity that has come to hand of the purchaser is accepted (step 3005) (see an evaluation result input view shown in FIG. 11 and described later). Specifically, information such as information as to whether the contents of the information provision suitably represent the purchased commodity, information as to whether contents of the information provision are correct, and information as to whether false information, information contrary to the fact or improper information is contained, is supposed.

If information indicating the evaluation concerning the information provision is input at the step 3005, the purchaser terminal 100 makes a decision whether the evaluation indicates that “the contents of the information provision is false”, and transmits the input information to the shopping site operation apparatus 120 (step 301). If the received information is information indicating that information provision contains false contents, the shopping site operation apparatus 120 stores information for imposing a penalty on the information provider who provided the information, in the user information management unit 123 (step 302). As a specific example of the penalty, it is considered to limit the use of the online shopping for a fixed period of time, decrease points owned by the information provider (points added for the user on the basis of the use of the online shopping, such as cash back points, which can be used for subsequent online shopping, or points that can be exchanged for other commodities), or decrease indexes (points) indicating the reliability of the information provider in the site of the online shopping.

If there is no false in the contents of the provided information at the step 301, the shopping site operation apparatus 120 stores information to the effect that a privilege is granted for the information provider who provided the information, in the user information management unit 123 on the basis of the information transmitted from the purchaser terminal 100 (step 303). Herein, as the privilege, specifically it is supposed to increase the reliability points or privilege points owned by the information provider, or cash back (pay back) by several percents of the price of the sold commodity.

The shopping site operation apparatus 120 transmits information as to processing of which of the steps 302 and 303 has been conducted, to the purchaser terminal 100 and the information provider terminal 110 as information provision result information (step 304). Respectively in the purchaser terminal 100 and the information provider terminal 110, the browsing processing units 102 and 112 display the received information provision result information (steps 305 and 306). A view displayed at this time is shown in FIG. 12.

By the way, at the step 301, the purchaser terminal 100 makes a decision on the information input as regards the information provision contents. Instead of this, a configuration in which the purchaser terminal 100 transmits the input information to the shopping site operation apparatus 120 and the shopping site operation apparatus 120 makes a decision whether the input information is correct may also be adopted. As a result, it is also possible for the user information management unit 123 to associate the decision with the evaluation which has been input to the purchaser terminal and store them.

The processing of storing the penalty or privilege giving executed at the step 302 or 303 may be conducted several days after the purchaser purchased the commodity.

FIG. 4 is a diagram showing an example of the user data table managed by the user information management unit 123. The user data table 400 includes a user ID 401 for identifying an online shopping user, a user name 402 associated with the user ID 401, a password 403 to be used by the user to log in, a user address 404, a mail address 405, a settlement account number (or card No. of a credit card) 406 to be used to settle accounts of the online shopping, self-introduction information 407 for storing hobbies and matters of interest of the user, reliability points 408 for counting the number of times the user conducted proper information provision, privilege points 409 for which addition is conducted when the user has conducted proper information provision, a reason why the reliability points have been decreased 410, which is an item for describing the reason in the case where the user has not conducted proper information provision, a purchase commodity history ID 411 for identifying a commodity purchase history in online shopping of the user, and a log 412 of messages transmitted and received when the user became a purchaser or an information provider.

The user logs in to the online shopping site by using the user ID 401 and the password 403 (the step 202 shown in FIG. 2). Thus it becomes possible for the user to receive service of purchasing desired commodities at the site. The user ID 401 is a unique number in the present system. The user writes self-introduction and matters the user desires to appeal, in the self-introduction information column 407.

After the user has logged in, commodities on sale are displayed on the purchaser terminal 100 (the step 204 shown in FIG. 2). If a commodity among them is selected, a list of information providers who provide information concerning the commodity is displayed (the step 205 shown in FIG. 2). As for information concerning the information providers displayed at this time among the items shown in FIG. 4, the user name 402 (especially users who are in the online state in which message transmission and reception are possible), the reliability points 408 and the self-introduction information 407 are displayed (see FIG. 10 described later).

The reliability points 408 represent an index indicating the reliability of the information provider at the site of the online shopping. For example, the number of times proper information provision was conducted is counted and stored. Therefore, the reliability points are decreased (by, for example, one) at the step 302 shown in FIG. 3, whereas the reliability points are increased (by one) at the step 303 shown in FIG. 3 The privilege points 409 are points increased when the information provider provides the purchaser with proper information. On the basis of the privilege points 409, the user obtains a privilege at the shopping site. At the step 303 shown in FIG. 3, therefore, a fixed portion of a price of a commodity purchased by the purchaser is paid back as cash, or points that can be used in subsequent online shopping are given, as a privilege in return for provision of proper information. This result is stored in the privilege points 409. On the other hand, at the step 302 shown in FIG. 3, the privilege points of the user are decreased as a penalty for failing to provide proper information.

In the case where messages are exchanged between the purchaser terminal 100 and the information provider terminal 110 at the steps 206 to 212 shown in FIG. 2, messages transmitted from them are stored in the message log 412 at the steps 207 and 210 shown in FIG. 2.

FIG. 5 is a diagram showing an example of a commodity data table managed by the commodity information management unit 122. The commodity data table 500 includes a commodity ID 501, a commodity name 502, a commodity price 503 and a commodity image 504. The commodity ID 501 is a number for identifying a commodity, and it is a unique number in the present system.

In the case where the purchaser has selected a commodity displayed on the browsing processing unit 102 on the purchaser terminal 100, the purchaser terminal 100 transmits the commodity ID 501 of the selected commodity to the user information management unit 123 via the network 140. The shopping site operation apparatus 120 refers to the purchase commodity history ID 411 in the user data table 400 (FIG. 4) stored in the user information management unit 123 on the basis of the received commodity ID, and extracts the user name 402, the reliability points 408 and the self-introduction information 407 of users having the purchase history of that commodity. Furthermore, on the basis of the received commodity ID, the shopping site operation apparatus 120 retrieves the commodity name 502, the commodity price 503 and the commodity image 504 concerning the commodity, and extracts those kinds of information. Thereafter, the shopping site operation apparatus 120 transmits the extracted kinds of information to the purchaser terminal 100, and the dedicated messenger processing unit 101 on the purchaser terminal 100 displays the received information (the step 205 shown in FIG. 2).

FIG. 6 is a diagram showing an example of a structure of data transmitted from the purchaser terminal 100 to the shopping site operation apparatus 120 at the time of commodity purchase procedure (the step 214 shown in FIG. 2). Data input to the purchaser terminal at the step 214 shown in FIG. 2, includes a purchaser's user ID 601, user IDs 602 of information providers who have provided information at the time of purchase, a ratio of the usefulness degree 603 of each information provider in the case where the purchaser has obtained from a plurality of information providers, and a commodity ID 604 of a purchase commodity. If information is input to these fields, the purchaser terminal 100 transmits the information to the shopping site operation apparatus 120 (the step 214 shown in FIG. 2). Upon receiving the information (the step 215 shown in FIG. 2), the shopping site operation apparatus 120 preserves the information in the user information management unit 123 in a form of a data table 600 at the time of commodity purchase. In addition, the sales processing unit 121 conducts sales processing according to the received information.

The ratio of the usefulness degree 603 of each information provider will now be described. In the case where information is provided for the purchaser by a plurality of information providers, the degree of contribution in information provision is judged by inputting ratios among a plurality of pieces of information in degree of usefulness (step 303 shown in FIG. 3).

The purchaser's user ID 601 and the user IDs 602 of information providers may be displayed in the input column by diverting the user ID used in the login and user IDs of information providers obtained when accepting information provided by message transmission and reception to this purpose, instead of accepting inputs whenever purchase is conducted. Thus inputting can be simplified.

FIG. 7 is a diagram showing an example of data structure transmitted to the shopping site operation apparatus 120 in the case where the purchaser terminal 100 has judged at the step 301 shown in FIG. 3 that the evaluation which has been input by the purchaser includes the information representing that “Information provided from the information provider is false.”

The transmitted information includes a purchaser's user ID 701, an information provider's user ID 702, a commodity ID 703 of the purchased commodity, and a comment 704 on the provided information. Upon receiving this information, the shopping site operation apparatus 120 preserves this information in an evaluation content data table 700 in the user information management unit 123.

The purchaser's user ID 701 is the user ID of the purchaser who reports that the contents of provided information were false. The information provider's user ID 702 is a user ID of an information provider judged by the purchaser that provided information is false.

FIG. 8 is a diagram showing an example of data concerning information providers held by the purchaser terminal 100 or the information provider terminal 110. The data table 800 includes user IDs 801. The user IDs 801 are user IDs of other users (information providers) with whom a certain user (purchaser) has exchanged information. The user IDs 801 are preserved on a storage device, such as a memory or a hard disk, on the purchaser terminal 100 or the information provider terminal 110.

FIG. 9 shows an example of a view displayed by the browsing processing unit 102 on the user terminal 100 (the step 204 shown in FIG. 2) in the case where the user has logged in to the shopping site. A shopping site view 900 includes a commodity image display section 901, a commodity name display section 902, a commodity price display section 903 and a commodity purchase button display section 904.

In the commodity image display section 901, image information stored in the commodity image 504, which is included in the commodity data table 500 shown in FIG. 5, is displayed. In the same way, the commodity name 502 is displayed in the commodity name display section 902, and the commodity price 503 is displayed in the commodity price display section 903. The commodity selection button 904 is clicked (or the commodity selection button 904 is depressed). The commodity ID 501 of the selected commodity is used as a key. If there are information providers of the commodity, a list of the information providers is displayed (the step 205 shown in FIG. 2, see FIG. 10 described later).

FIG. 10 shows a view example of the list of information providers concerning the selected commodity and a transmission message creation view, displayed by the dedicated messenger processing unit 101 on the purchaser terminal 100 when a commodity has been selected at the step 205 shown in FIG. 2.

The dedicated messenger view 1000 includes a user name display section 1001, a reliability point display section 1002, a self-introduction information display section 1003, a message display section 1004, a transmission button 1005 and an end button 1006.

The user name 402 of an information provider who has a purchase history of the commodity selected at the step 205 shown in FIG. 2 and who is in the online state, the reliability points 408 corresponding to the information provider, and the self-introduction information 407 are displayed in the information provider name display section 1001, the reliability point display section 1002 and the self-introduction information display section 1003, respectively. By referring to those kinds of displayed information, the purchaser can select an information provider with whom the purchaser desires to exchange information, from among information providers displayed in the information provider name display section 1001, and create a message to be transmitted to the selected information provider. Upon selection of an information provider, the purchaser terminal 100 accepts input (creation) of the message in the message display section 1004. Upon sensing that a transmission button 1005 has been selected (or depressed), the purchaser terminal 100 transmits the message to an information provider terminal of the selected information provider via the shopping site operation apparatus (the step 206 shown in FIG. 2).

If the steps 206 to 212 shown in FIG. 2 are executed (i.e., if message transmission and reception (information exchange) is conducted between the purchaser and the information provider), the exchanged messages are displayed in the message display section 1004 shown in FIG. 10 in a form in which the message enterer (creator) can discriminate between them. By clicking an end button 1006, a series of message transmission and reception (information exchange) operations are finished (Yes at the step 212 shown in FIG. 2).

FIG. 11 shows an example of an evaluation result input view for information provision, displayed on the purchaser terminal 100 at the step 301 shown in FIG. 3. The evaluation result input view 1100 includes a purchaser's user ID display section 1101, a commodity ID display section 1102 of a purchased commodity, a commodity information display section 1103 for displaying commodity information corresponding to the commodity ID, a message log display section 1104 for displaying a log of messages transmitted and received at the time of purchase of a commodity, a comment display section 1105 for displaying a comment input as regards contents of information provided with respect to the commodity, a transmission button 1106, an information provider information display section 1107, and an evaluation display section 1108 for displaying evaluation of contents of information provision.

The purchaser terminal 100 logs in to the online shopping site by using the input user ID and password, and displays the evaluation result input view 1100. A user ID input at the time of login is displayed in the user ID display section 1101. A commodity ID of a commodity to be evaluated as regards the information provision is displayed in the commodity ID display section 1102. A commodity ID input by the user may be displayed, or a commodity ID corresponding to the commodity displayed in the commodity information display section 1103 may be displayed. Information (such as commodity name, model No. and purchase date) concerning a commodity selected from among commodities purchased by the user in the past, or a commodity input by the user is displayed in the commodity information display section 1103.

A log of messages transmitted and received between the purchaser terminal and the information provider terminal when a user purchases the commodity displayed in the commodity ID display section 1102 is displayed in the message log display section 1104. This message log is displayed in the following manner. The purchaser terminal 100 transmits the user ID and the commodity ID respectively input to (or displayed in) the user ID display section 1101 and the commodity ID display section 1102 to the shopping site operation apparatus 120. The shopping site operation apparatus 120 retrieves the message log (the steps 207 and 210 shown in FIG. 2) preserved in the user information management unit 123 on the basis of the received user ID and commodity ID. The shopping site operation apparatus 120 transmits the corresponding message log and information (such as the user ID and the user name) identifying an information provider who has provided information in the message log to the purchaser terminal 100. The message log is displayed in the message log display section 1104 on the purchaser terminal 100.

Information identifying an information provider who has provided the message (provided information) displayed in the message log display section 1104 is displayed in the information provider display section 1107. As information identifying the information provider, there are a user ID of the information provider and an information provider name (including a nickname). In the case where the purchaser has exchanged information with a plurality of information providers when purchasing a certain commodity, a message log the user desires to watch is selected from among a plurality of message logs and displayed in the message log display section 1104, and switching is conducted among a plurality of message logs for display. Such a configuration may be adopted. In that case, an information provider's ID corresponding to the displayed message log may be displayed in the information provider display section 1107. Such a configuration may also be adopted.

When the purchaser inputs a comment as regards the purchased commodity on the basis of the message log displayed in the message log display section 1104, the purchaser inputs the comment by using an input device, such as a keyboard (not shown), and the input comment is displayed in the comment display section 1105. In the example shown in FIG. 11, information to the effect that “a digital camera capable of picking up a dynamic image” is provided in the message log display section 1104. Nevertheless, as a matter of fact, the dynamic image cannot be picked up. Therefore, a comment concerning the information provision (i.e., a comment to the effect that “the provided information is not correct”) is input and displayed in the comment display section 1105.

The purchaser terminal 100 causes the purchaser to select evaluation of the information provision, and the selected result is displayed in the evaluation display section 1108. As the evaluation to be selected, three-level evaluation such as “plus evaluation, minus evaluation, and neither of them,” or two-level evaluation such as “the provided information is correct, or incorrect” or “the provided information is useful or useless” is conceivable. In the example shown in FIG. 11, the input comment is “the provided information is incorrect.” Therefore, the evaluation becomes minus, and the minus evaluation is selected and displayed.

The comment input and the evaluation selection conducted by the purchaser are finished. Upon sensing that the transmission button 1106 has been depressed by the purchaser, the purchaser terminal 100 transmits the comment displayed in the comment display section 1105 (i.e., the comment input by the purchaser), the evaluation displayed in the evaluation display section 1108 (i.e., the evaluation of the provided information), and the user ID of the information provider in the evaluated message log to the shopping site operation apparatus 120. The shopping site operation apparatus 120 stores the received comment in the user data table 400 in the user information management unit 123. At this time, on the basis of the received user ID of the information provider, the shopping site operation apparatus 120 stores the received comment so as to associate it with the user ID of the information provider in the user data table 400.

In the example of FIG. 11, evaluation of the information provided by the information provider is “minus.” Therefore, points stored in the reliability points 408 of the information provider in the user table 400 shown in FIG. 4 are decreased (the step 302 shown in FIG. 3). The comment input by the purchaser is stored in the reason why the reliability points have been decreased 410.

FIG. 12 shows an example of the information provision result information view displayed at the steps 305 and 306 shown in FIG. 3.

An information provision result information view 1200 includes an additional point display section 1201, a privilege point display section 1202, a reliability point display section 1203, and a point reduction reason display section 1204.

The additional point display section 1201 indicates several percents of the purchase commodity price or the privilege points calculated at the step 303 shown in FIG. 3. The privilege point display section 1202 indicates the privilege points the user has at the present time (the item 409 shown in FIG. 4). The reliability point display section 1203 indicates the current reliability points 408 of the user. The point reduction reason display section 1204 indicates the reason why the reliability points have been reduced (the item 410 shown in FIG. 4).

According to the online shopping system of the present embodiment as heretofore described, users of the online shopping exchange information with each other in real time by using a messenger program, and thereby reliable commodity information is provided for a person who is about to purchase a commodity. Therefore, the user can obtain reference information for the commodity purchase. In addition, privilege points are given to an information provider for an information provision act, provided that another user has purchased a commodity because of the information provision. Since this leads to an incentive to a sales promotion action, information providers take the lead in providing information. Furthermore, since information providers introduce other commodities relating to a commodity purchased by the purchaser, activation of online shopping and sales promotion of commodities are brought about.

In general, individual information, such as names, addresses and credit card numbers, of shopping site users are registered in the shopping site. Since the shopping site users are thus persons whose identities can be recognized, it is difficult for the shopping site users to impersonate another person, and it can be expected that highly reliable information is provided for the purchaser.

In the foregoing description, both the purchaser and the information provider are users of the online shopping site, and a user can become either of the purchaser and the information provider. For example, a purchaser who has purchased a certain commodity becomes an information provider as well by providing information as regards the commodity.

In the case where the purchaser has actually purchased a commodity, incentive points are given to an information provider in the present embodiment.

However, it is also possible to adopt a configuration in which a privilege (incentive points) is added for an information provider, provided that the information provider has provided information useful to the purchaser even if the purchaser does not finally purchase any commodity. In this case, however, it is probable that incentive points are given over and over again by simply exchanging information between an information provider and the purchaser. Therefore, it is also possible to adopt a configuration in which an upper limit is provided in the number of times of information exchange provided with incentive points, in information exchange between a specific information provider and the purchaser concerning a certain commodity.

The present invention brings about an effect that in the online shopping system a person (purchaser) who is about to purchase a certain commodity can obtain information concerning the commodity from persons (information providers) who purchased the commodity in the past.

It should be further understood by those skilled in the art that although the foregoing description has been made on embodiments of the invention, the invention is not limited thereto and various changes and modifications may be made without departing from the spirit of the invention and the scope of the appended claims.

1. An online shopping method for exchanging information concerning a commodity at a shopping site where commodities can be purchased online, the online shopping method comprising the steps of:
displaying commodities on sale at the shopping site;
displaying information concerning information providers who are included in information providers for a commodity selected from among the displayed commodities and who are currently logged on to the shopping site;
accepting a message input for the displayed information providers as regards the selected commodity;
transmitting the input message to an information provider selected from the information providers;
receiving a reply message for the transmitted message from the information provider; and
granting a privilege to the information provider who has provided the received reply message, provided that information to an effect that the selected commodity is purchased is input.

2. The online shopping method according to claim 1, wherein the privilege for the information provider is determined on a basis of evaluation of information provided by the information provider, input by a purchaser of the commodity.

3. The online shopping method according to claim 2, wherein the privilege is points that can be used in the online shopping.

4. The online shopping method according to claim 2, wherein the privilege is to give back a fixed proportion of a price of a commodity for which the information provider has provided information, to the information provider.

5. An online shopping system for exchanging information concerning a commodity at a shopping site where commodities can be purchased online, the online shopping system comprising:
a purchaser terminal comprising a display unit for displaying information concerning information providers who are included in information providers corresponding to a commodity on sale at the shopping site and who are currently logged on to the shopping site, and a messenger processing unit for transmitting a message concerning a commodity corresponding to the information provider to an information provider selected from the information providers and receiving a reply message for the message from the information provider; and
a shopping site operation apparatus comprising a commodity management unit for storing commodities on sale at the shopping site, and a user information management unit for storing information concerning users of the shopping site,
wherein the purchaser terminal transmits evaluation concerning the received reply message to the shopping site operation apparatus, and
the shopping site operation apparatus grants a privilege to the information provider corresponding to the reply message that has become a subject of the evaluation.

6. The online shopping system according to claim 5, wherein the user information management unit stores the information provider and a privilege corresponding to the information provider so as to associate them with each other.

7. The online shopping system according to claim 5, wherein the shopping site operation apparatus stores the message transmitted from the purchaser terminal and the reply message to the message as a message log for the commodity.

8. The online shopping system according to claim 5, wherein:
the shopping site operation apparatus further comprises a sales processing unit responsive to reception of information to an effect that a commodity selected at the purchaser terminal is purchased, for conducting sales processing of the commodity, and
after the sales processing unit has finished sales processing of the selected commodity, the shopping site operation apparatus grants a privilege corresponding to the evaluation received from the purchaser terminal.

9. The online shopping system according to claim 5, wherein the information provider is a user of the shopping site who has a purchase history of the corresponding commodity.

10. A computer program executed in an online shopping system for exchanging information concerning a commodity at a shopping site where commodities can be purchased online, the computer program comprising the steps of:
displaying commodities on sale at the shopping site;
displaying information concerning information providers who are included in information providers for a commodity selected from among the displayed commodities and who are currently logged on to the shopping site;
accepting a message input for the displayed information providers from a purchaser of the selected commodity;
transmitting the input message to a selected information provider;
receiving a reply message for the transmitted message from the information provider;
transmitting identification information of the selected commodity, identification information of a purchaser who purchases the selected commodity, and identification information of the information provider, provided that information to an effect that the selected commodity is purchased is input; and
granting a privilege to the information provider who has provided the received reply message, provided that information to an effect that the selected commodity is purchased is input.

11. A method for improving reliability of information provided for a commodity purchaser by an apparatus for operating a shopping site where commodities can be purchased online, the method comprising the steps of:
displaying information of commodities and a list of information providers concerning a commodity on a terminal of a purchaser who has logged in to the shopping site, by using the operation apparatus;
selecting, on the terminal of the purchaser, an information provider from the list of information providers, and transmitting a message concerning a commodity desired to purchase to a terminal of the selected information provider via the operation apparatus;
receiving the message at the terminal of the selected information provider, and transmitting a reply message for the received message to the terminal of the purchaser via the operation apparatus;
after the purchaser has purchased the commodity from the shopping site, transmitting a comment including evaluation concerning the reply message from the terminal of the purchaser to the operation apparatus; and
in the operation apparatus, receiving the comment, updating evaluation of the selected information provider, and notifying the selected information provider of the updated evaluation.

12. The method according to claim 11, wherein the listed information providers are currently logged on at a point of time at which the purchaser is currently logged on, and the message and the reply message are transmitted and received online.

13. The method according to claim 11, wherein the message and the reply message are stored in a storage device in the operation apparatus.

14. The method according to claim 11, the transmission and reception of the message and the reply message are repeated between the terminal of the purchaser and the terminal of the selected information provider a plurality of times.
